(19) United States
(12) Patent Application Publication
(10) Pub. No.: US 2003/0202115 A1
(43) Pub. Date: Oct. 30, 2003

(54) Image capturing device performing divided exposure

(75) Inventors: Kunihiko Sugimoto, Sakai-Shi (JP); Hiroaki Kubo, Muko-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/417,599

(22) Filed: Apr. 17, 2003

(30) Foreign Application Priority Data
Apr. 26, 2002 (JP) 2002-125472

(51) Int. Cl. H04N 5/235

(52) U.S. Cl. 348/362

(57) ABSTRACT

A digital camera obtains a plurality of images by performing divided exposure of the CCD image sensor, and generates a shot image of the subject by composing the images. When divided exposure is performed, preset one mode is identified from among an image quality priority mode and a shooting speed priority mode. Then, by dividing the set exposure time at the time of shooting by the number of divisions defined by the identified mode, divided exposure control of the CCD image sensor is performed. The number of divisions in the image quality priority mode is larger than that in the shooting speed priority mode.

This application is based on the application No. 2002-125472 filed in Japan, the contents of which are hereby incorporated by reference.

1. Field of the Invention

The present invention relates to an image capturing device, and more particularly, to a technique of divided exposure in an image capturing device.

2. Description of the Related Art

Conventionally, when long-time exposure is performed in digital cameras, since the noise level increases, the quality of images obtained by performing long-time exposure is degraded.

Therefore, to prevent the image quality degradation caused at the time of long-time exposure, Japanese Laid-Open Patent Application No. H05-236422 discloses a technique related to divided exposure, that is, a technique to obtain an image corresponding to a long-time exposure by integrating short-time exposures.

Japanese Laid-Open Patent Application No. 2001-24950 discloses a technique related to the setting of the exposure time for ensuring image quality in consideration of quantization noises caused by an A/D converter.

When the number of divisions at the time of long-time exposure is increased to improve image quality, the number of image frames increases, so that the total time required for transferring image signals also increases. That is, when the number of divisions at the time of divided exposure is m and the time required for transferring image signals of one frame is TR, the time required for transferring the entire image at the time of divided exposure is m×TR, and the transfer time increases as the number of divisions m increases. As a result, the overall shooting time (the exposure time plus the transfer time) increases.

Therefore, when the user wants to perform the next shooting immediately, it occurs that the next shooting cannot be performed because the previous shooting processing has not been completed yet. The operability at the time of long-time exposure is thus poor. In particular, the number of pixels of the image sensor employed for digital cameras has tended to increase in recent years. The transfer time TR required for transferring image signals of one frame from the image sensor increases as the number of pixels increases, so that the deterioration in the operability at the time of long-time exposure is a significant problem.

Moreover, according to the conventional divided exposure, since no consideration is given to bulb shooting, appropriate divided exposure cannot be performed at the time of bulb shooting, so that high-quality shot images cannot be obtained.

Further, although it is necessary to perform a divided exposure control most suitable for the kind of the subject when divided exposure is performed, no consideration is given to the kind of the subject in the conventional divided exposure.

That is, in conventional digital cameras, divided exposure cannot be performed in the condition desired by the user, and the operability is poor at the time of divided exposure.

Accordingly, the present invention is made in view of the above-mentioned problems, and an object thereof is to provide an image capturing device realizing a divided exposure suitable for the shooting condition, suppressing noises, and being capable of efficiently performing divided exposure shooting.

Another object of the present invention is to realize a divided exposure technique where bulb exposure can be performed.

### SUMMARY OF THE INVENTION

To attain the above-mentioned objects, an image capturing device according to the present invention obtaining a plurality of images by performing divided exposure of an image sensor for forming a subject image, is provided with: a selector for selecting one of an image quality priority mode in which the number of divisions at the time of divided exposure is set to a first value and a shooting speed priority mode in which the number of divisions is set to a second value lower than the first value; a controller for performing, when exposure of the image sensor is performed, a divided exposure control of the image sensor by dividing a set exposure time at the time of shooting by the number of divisions defined by the mode selected by the selector; and an image generator for generating a shot image of the subject by composing the plurality of images obtained by the divided exposure.

According to the present invention, in the image quality mode, high-quality shot images with few noises can be obtained and in the speed priority mode, the efficiency of shooting can be improved.

Moreover, to attain the above-mentioned object, the image capturing device according to the present invention is provided with: an image sensor for forming a subject image; a first selector for selecting a bulb shooting mode; an exposure time determiner for determining a unit exposure time in the bulb shooting mode; a controller for repetitively performing divided exposure of the image sensor every unit exposure time during the bulb shooting; and an image generator for generating a shot image of the subject by composing a plurality of images generated by the divided exposure performed every unit exposure time.

According to the present invention, divided exposure can be excellently performed and high-quality shot images with few noises can be obtained also in bulb shooting.

Moreover, to attain the above-mentioned object, an image capturing device according to the present invention obtaining a plurality of images by performing divided exposure of an image sensor for forming a subject image, is provided with: a shooting condition determiner for determining a shooting condition when a subject is shot; a unit exposure time determiner for determining a unit exposure time at the time of the divided exposure in accordance with the shooting condition; a controller for performing a divided exposure control of the image sensor every unit exposure time determined by the unit exposure time determiner when exposure of the image sensor is performed; and an image generator for generating a shot image of the subject by composing the plurality of images obtained by the divided exposure.

According to the present invention, a divided exposure suitable for the shooting condition can be performed, and high-quality images suitable for the shooting condition can be obtained.

In the following description, like parts are designated by like reference numbers throughout the several drawings.

### BRIEF DESCRIPTION OF THE DRAWINGS

FIG. 1 is a front view showing the external structure of a digital camera;

FIG. 2 is a rear view showing the external structure of the digital camera;

FIG. 3 is a block diagram showing the internal structure of the digital camera;

FIGS. 4(a) and 4(b) show a relationship between the exposure time and the noise amount;

FIG. 5 is a block diagram showing the internal structure of the digital camera in a case where divided exposure is applied in bulb shooting; and

FIG. 6 is a block diagram showing the internal structure of the digital camera in a case where a divided exposure suitable for the shooting scene is applied.

### DETAILED DESCRIPTION OF THE PREFERRED EMBODIMENT

Hereinafter, embodiments of the present invention will be described in detail with reference to the drawings.

1. First Embodiment

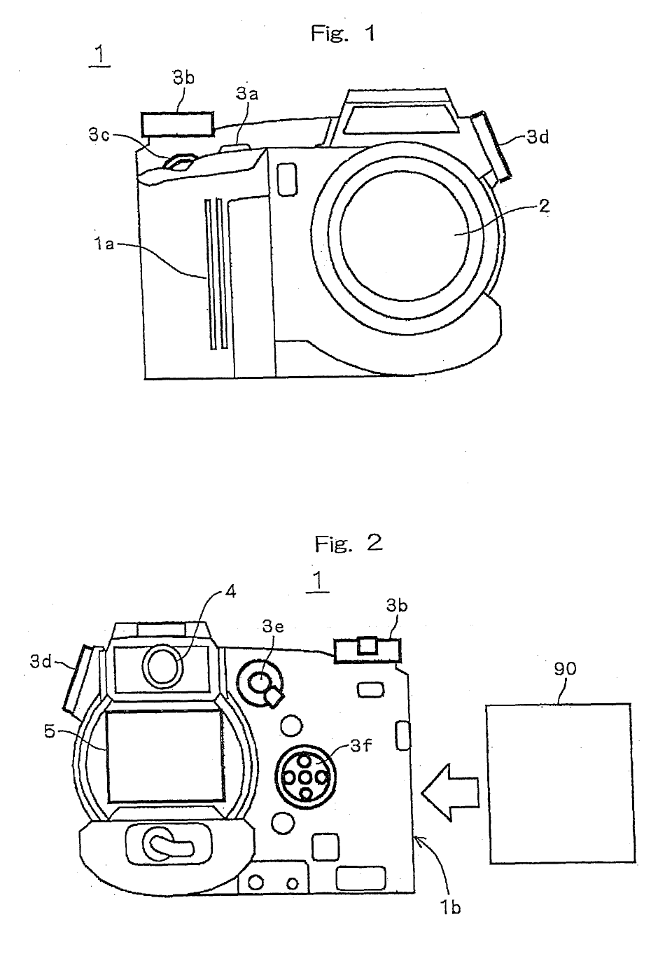

FIGS. 1 and 2 are views showing the external structure of a digital camera 1. FIG. 1 is a front view. FIG. 2 is a rear view.

A taking lens 2 is provided on the front of the digital camera 1. The taking lens 2 is structured so as to image light from the subject with respect to an image sensor disposed inside the taking lens 2.

A shutter button (release button) 3a and a dial 3c are provided above a grip la of the digital camera 1. The shutter button 3a is a switch for the user to provide a shooting instruction. In response to a depression of the shutter button 3a, the digital camera 1 starts actual shooting for shooting an image for recording. The dial 3c is an operation portion for the user to manually set the shutter speed for actual shooting. Bulb shooting can also be set by operating the dial 3c.

A mode switching dial 3b for switching between a “shooting mode” and a “playback mode” is provided on the top of the digital camera 1. The shooting mode is for generating shot image data by shooting the subject. The playback mode is for playing back image data recorded on a memory card 90, on a liquid crystal display (hereinafter, referred to as LCD) 5 provided on the back of the digital camera 1.

Moreover, as shown in FIG. 1, a function button 3d for selecting from among a “program mode,” an “aperture priority mode” and a “shutter speed priority mode” which are operation modes for shooting is provided on an upper side of the digital camera 1. When the user selects one of these modes by operating the function button 3d, the shutter speed based on the selected operation mode is set at the time of shooting.

A slot 1b for inserting the memory card 90 which is a detachably attachable recording medium is provided on a side of the digital camera 1 as shown in FIG. 2. The image data obtained by actual shooting is recorded onto the memory card 90 set in the slot 1b.

The LCD 5 and an electronic viewfinder (hereinafter, referred to as EVF) 4 for performing live-view display during standby prior to actual shooting and playing back shot images obtained by actual shooting are provided on the back of the digital camera 1.

Moreover, a menu button 3e for causing various setting screens to be displayed on the LCD 5 and a control button 3f for operating the setting screens and the like displayed on the LCD 5 are provided on the back of the digital camera 1. The user can make various settings on the digital camera 1 by moving a cursor within the setting screen displayed on the LCD 5 by operating the control button 3f. For example, when a shooting scene suitable for the kind of the subject is set, the user can select, by operating the menu button 3e and the control button 3f, a shooting scene suitable for the condition and the like of the subject from among a plurality of shooting scenes such as “evening scene,” “night scene” and “portrait” while confirming the image displayed on the LCD 5.

Moreover, when long-time exposure is performed in the digital camera 1, whether to perform divided exposure or not can also be set by the user operating the menu button 3e and the control button 3f. Specifically, by the user operating the menu button 3e and the control button 3f, one mode can be selected as the exposure operation mode for longtime exposure from among an “image quality priority mode,” a “speed priority mode” and a “normal mode.” By doing this, it is defined what kind of exposure operation is performed when long-time exposure is performed in actual shooting of the digital camera 1. The “image quality priority mode” and the “speed priority mode” are exposure operation modes for performing divided exposure at the time of long-time exposure. The “normal mode” is an exposure operation mode for performing long-time continuous exposure without performing divided exposure at the time of long-time exposure.

In the description given below, a case where actual shooting is performed with the shutter speed being set to not less than one second is included in long-time exposure. A case where bulb shooting is set is also included in long-time exposure.

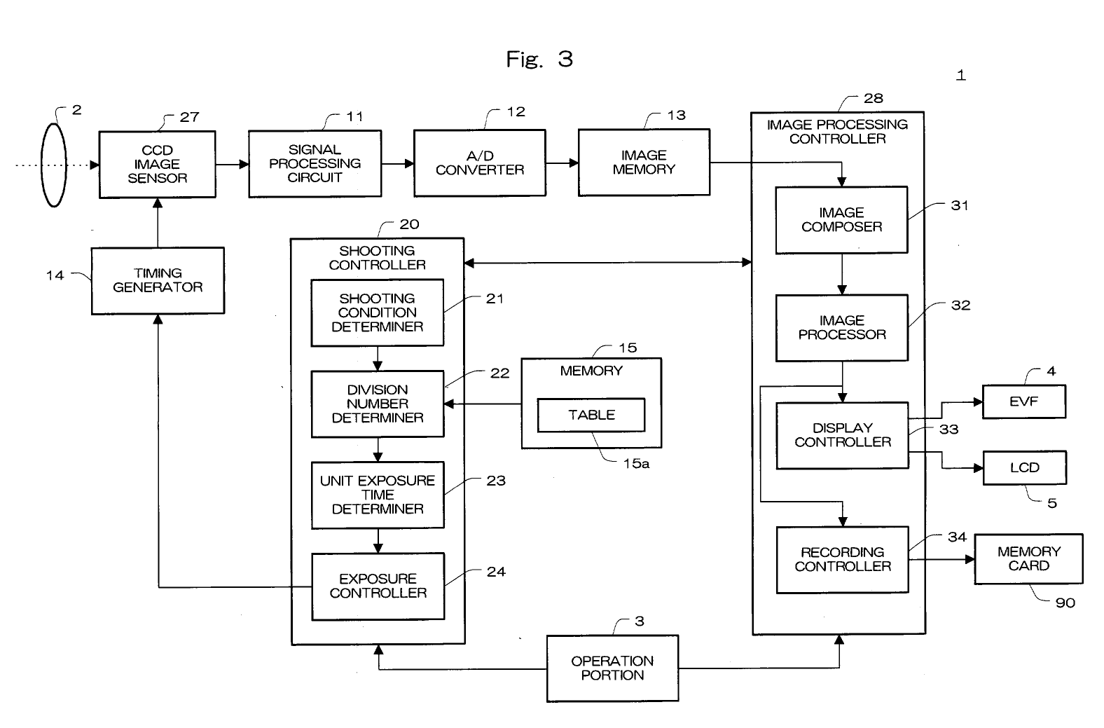

Next, the internal structure of the digital camera 1, especially the internal structure for performing divided exposure in the digital camera will be described. FIG. 3 is a block diagram showing the internal structure of the digital camera 1.

The digital camera 1 has as its internal elements a CCD image sensor 10, a signal processing circuit 11, an image memory 13, a timing generator 14, a memory 15, a shooting controller 20 and an image processing controller 30 in addition to the above-described elements. The operation portion 3 includes the shutter button 3a, the mode switching dial 3b, the dial 3c, the function button 3d, the menu button 3e and the control button 3f.

Light from the subject is incident, through the taking lens 2, on the CCD image sensor 10 having a function as a photoelectric conversion element. The CCD image sensor 10 performs an exposure operation based on sampling pulses from the timing generator 14, performs photoelectric conversion for each pixel, and stores pixel signals (pixel values) corresponding to the quantity of the incident light. Then, the CCD image sensor 10 successively transfers the pixel values stored for each pixel in the exposure operation, as analog signals to the signal processing circuit 11 in response to the sampling pulses from the timing generator 14.

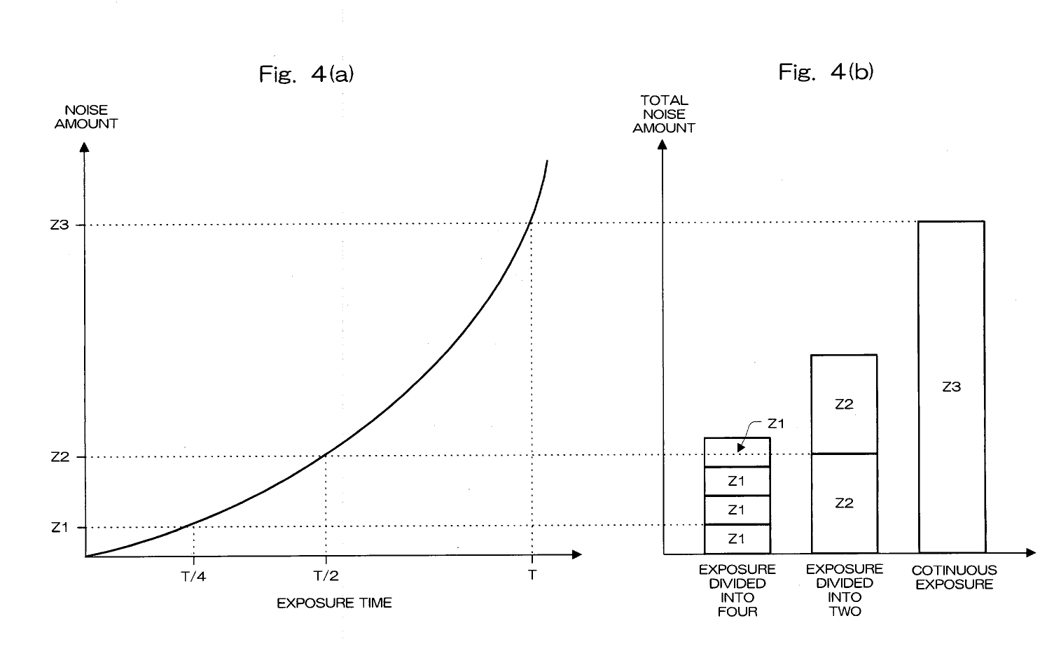

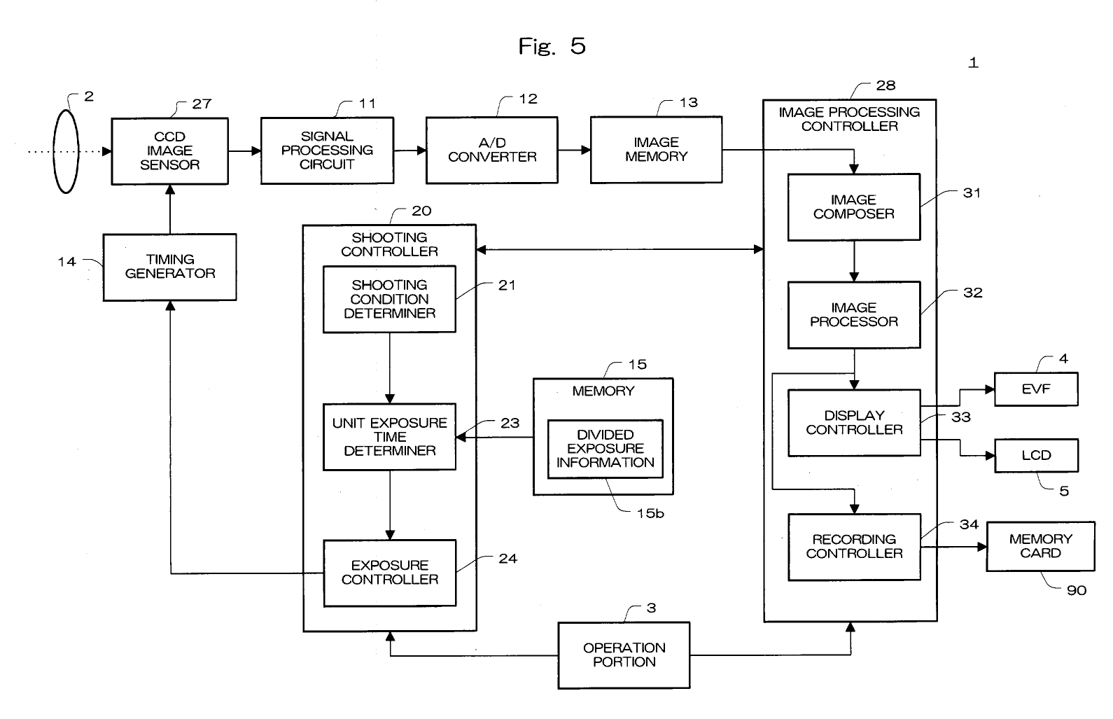

Now, a relationship between the amount of noises accumulated in each pixel of the CCD image sensor 10 and the exposure time will be described. FIGS. 4(a) and 4(b) show the relationship between the exposure time and the noise amount. When the continuous exposure time of the CCD image sensor 10 is increased, the amount of noises accumulated in each pixel exponentially increases as shown in FIG. 4(a). For this reason, when a continuous exposure of an exposure time T is performed in the CCD image sensor 10, a noise amount Z3 is included in the pixel signal of each pixel as the total noise amount as shown in FIG. 4(b).

On the contrary, for example, when exposure is performed twice with an exposure time T/2, the total exposure time is T, so that an exposure time equal to that in the case where the continuous exposure of the exposure time T is performed is secured. When divided exposure is performed with the exposure time T divided into two, noise amounts Z2 of two times are included in the pixel signal of each pixel, so that the total noise amount is 2×Z2. This total noise amount is smaller than the total noise amount Z3 in the case where the continuous exposure of the exposure time T is performed. That is, when divided exposure is performed, the noise components included in the pixel signal of each pixel are less than those in the case where the continuous exposure is performed, so that the quality of the shot image is improved.

Further, considering a case where an exposure is performed four times with an exposure time T/4, the total exposure time is T also in this case, so that an exposure time equal to that in the case where the continuous exposure of the exposure time T is performed is secured. When divided exposure is performed with the exposure time T divided into four, noise amounts Z1 of four times are included in the pixel signal of each pixel, so that the total noise amount is 4×Z1. This total noise amount is smaller than the total noise amount Z3 in the case where the continuous exposure of the exposure time T is performed, and is also smaller than the total noise amount 2×Z2 in the case where the two-part divided exposure of the exposure time T is performed. That is, when divided exposure is performed, the amount of noises included in the pixel signals of the pixels can be reduced by increasing the number of divisions at the time of divided exposure, so that the quality of the shot images is improved.

For this reason, when the shutter speed set by the user or the shutter speed determined by automatic computing is used as the set exposure time applied at the time of actual shooting, in a case where the continuous exposure of the set exposure time is a long-time exposure, a high-quality image with few noise components can be generated by performing divided exposure as described above.

When the number of pixels of the CCD image sensor 10 is increased, the amount of data included in the image signals of one frame increases accordingly, so that the transfer time TR required for transferring the image signals increases. By the CCD image sensor 10 repeating exposure and signal transfer at the time of divided exposure, the time to the completion of shooting of a number m (m is defined as the number of divisions) of frame images (shooting time) is increased.

When only an improvement in the quality of the shot images which the user finally obtains is required, the increase in the shooting time is hardly a problem. However, when the user intends to continuously perform a shooting operation (a depression of the shutter button 3a), the increase in the shooting time is a problem because it limits the next shooting operation.

Therefore, in the first embodiment, the “image quality priority mode” and the “speed priority mode” are provided as mode settings for performing divided exposure in the digital camera 1. When the “image quality priority mode” is set, a divided exposure operation is performed with which shot images of the highest quality can be obtained. When the “speed priority mode” is set, a divided exposure operation is performed with which high-quality images can be obtained with efficiency.

In the first embodiment, when the “image quality priority mode” or the “speed priority mode” is set as the exposure operation for long-time exposure and the set exposure time is longer than one second, the shooting controller 20 indicates a divided exposure to the timing generator 14 as described later. By this indication, the timing generator 14 generates sampling pulses for the CCD image sensor 10 so that the divided exposure indicated by the shooting controller 20 is realized.

The signal processing circuit 11 performs predetermined signal processing such as sensitivity adjustment and noise removal on the analog signals of each pixel obtained from the CCD image sensor 10. Then, the pixel signals having undergone the predetermined signal processing at the signal processing circuit 11 are input to the A/D converter 12, and converted from analog signals into digital signals. The pixel signals converted into digital signals by the A/D converter 12 are successively transferred to the image memory 13.

The image memory 13 has a memory area storing pixel signals of a plurality of frames. By the digitized pixel signals of one frame being stored in the image memory 13, image data of one frame is formed in the image memory 13. When divided exposure is performed at the CCD image sensor 10, image data of a plurality of frames corresponding to the number of divisions at the time of divided exposure is stored in the image memory 13. For example, when a three-part divided exposure is performed at the time of divided exposure, three frames of images are stored in the image memory 13.

The image processing controller 30 is implemented by a predetermined program being executed by a CPU provided in the digital camera 1, and performs an operation linked to the shooting controller 20. After actual shooting is finished, the image processing controller 30 reads out the image data stored in the image memory 13, and plays back the shot image on the EVF 4 or the LCD 5. Moreover, the image processing controller 30 has the function of accessing the memory card 90 and recording the shot image.

When divided exposure is applied in the digital camera 1, the image processing controller 30 functions as an image composer 31, an image processor 32, a display controller 33 and a recording processor 34.

The image composer 31 generates one shot image by composing a plurality of frame images (divided exposure images) obtained by divided exposure and stored in the image memory 13. For example, when four-part divided exposure is performed with the set exposure time being T and the unit exposure time at the time of divided exposure being T/4, since image data of four frames is stored in the image memory 13 by divided exposure, the image composer 31 generates one shot image by composing the images of four frames stored in the image memory 13.

Consequently, at the time of divided exposure, a shot image with fewer noise components can be obtained than at the time of continuous exposure of the set exposure time being T.

The image processor 32 performs predetermined image processing on the shot image generated by composing a plurality of frames obtained at the time of divided exposure. For example, white balance adjustment and image compression are performed at the image processor 32. The shot image having undergone image processing at the image processor 32 is supplied to the display controller 33 or the recoding processor 34.

The display controller 33 causes the shot image to be displayed on the EVF 4 or the LCD 5 by outputting the shot image input from the image processor 32 to the EVF 4 or the LCD 5. By doing this, the user can confirm the shot image.

The recording processor 34 records the shot image input from the image processor 32 onto the memory card 90. When the user visually confirms the shot image displayed on the EVF 4 or the LCD 5 and performs no deletion operation on the operation portion 3, the recording processor 34 records the shot image obtained from the image processor 32 onto the memory card 90.

The memory 15 stores a table 15a defining the number of divisions at the time of divided exposure. When the shooting controller 20 performs divided exposure control, the number of divisions at the time of divided exposure is determined by referring to the table 15a stored in the memory 15.

The shooting controller 20 is also implemented by a predetermined program being executed by the CPU provided in the digital camera 1, and has the function of performing overall control of the shooting operation in the digital camera 1.

When performing divided exposure control, the shooting controller 20 functions as a shooting condition determiner 21, a division number determiner 22, a unit exposure time determiner 23 and an exposure controller 24.

When the “image quality priority mode” or the “speed priority mode” is set as the exposure operation mode for long-time exposure, the shooting condition determiner 21 identifies the set exposure operation mode, and indicates it to the division number determiner 22. The exposure operation mode is previously selected and set by the user through the operation portion 3.

Moreover, the shooting condition determiner 21 supplies to the division number determiner 22 the shutter speed obtained by automatic computing or the shutter speed set by the user as the set exposure time T.

The division number determiner 22 determines the number of divisions m of set exposure time for long-time exposure in accordance with the set exposure operation mode and the set exposure time T. Specifically, the division number determiner 22 determines the number of divisions defined by a relationship between the set exposure time T and the exposure operation mode with reference to the table 15a stored in the memory 15.

In the table 15a stored in the memory 15, information as shown in the following Table 1 is stored:

TABLE 1

| | | |
|---|---|---|
| Set Exposure Time [sec] | 1˜5 | 6˜30 |
| Image Quality Priority Mode | 10 | 30 |
| Speed Priority Mode | 3 | 15 |

As shown in Table 1, in a case where the image quality priority mode is set, when the set exposure time T is one to five seconds, divided exposure is performed with the set exposure time T divided into ten. When the set exposure time T is six to 30 seconds, divided exposure is performed with the set exposure time T divided into 30.

In a case where the speed priority mode is set, when the set exposure time T is one to five seconds, divided exposure is performed with the set exposure time T divided into three. When the set exposure time T is six to 30 seconds, divided exposure is performed with the set exposure time T divided into 15.

That is, in both the image quality priority mode and the speed priority mode, the number of divisions is determined in correspondence with the set exposure time T, and the number of divisions in the image quality priority mode corresponding to a set exposure time T is larger than the number of divisions in the speed priority mode.

When an exposure operation based on the set exposure time T is performed, the lager the number of divisions is, the smaller the amount of noises is. Therefore, in the image quality priority mode where the quality of the finally obtained shot image has priority, the number of divisions of the set exposure time T is larger than that in the speed priority mode.

On the contrary, when the number of divisions is increased, the time required for the processing of transferring image signals from the CCD image sensor 10 (output processing) and the time required for the succeeding image composition are increased. That is, when the number of divisions at the time of divided exposure is m and the transfer time of one frame of image is TR, the time required for transferring all the images at the time of divided exposure (the transfer time) is m×TR. Thus, a long time is required for image transfer. Further, the number of frames to be composed by the image composer 31 increases, so that the time required for the image composer 31 to generate one shot image increases.

Therefore, in the speed priority mode, setting is made so that the image transfer can be efficiently completed and the shot image can be quickly generated although the quality of the finally obtained shot image is somewhat lower than that in the image quality priority mode. For this reason, the number of divisions at the time of divided exposure is smaller than that in the image quality priority mode.

Moreover, as shown in Table 1, in the table 15a, the number of divisions is set so as to increase as the set exposure time T increases in both the image quality priority mode and the speed priority mode. When the number of divisions is defined irrespective of the set exposure time, the unit exposure time increases as the set exposure time increases, so that the amount of noises contained in the finally obtained shot image increases. Therefore, as shown in Table 1, it is more desirable to set the number of divisions so as to increase as the set exposure time increases in both the image quality priority mode and the speed priority mode. This enables the amount of noises included in the finally obtained shot image to be reduced even when the set exposure time is long.

The contents of the table 15a shown in Table 1 are an example. Therefore, the contents of the information stored in the table 15a may be different from those shown in Table 1. However, in that case, it is also necessary that the number of divisions applied in the image quality priority mode be larger than that in the speed priority mode and the number of divisions be not more than a predetermined value. For example, when the number of divisions is set to not less than 200, the number of frames obtained by divided exposure is not less than 200, so that a long processing time is required for the succeeding image composition and this makes it impossible to quickly start the next shooting. Therefore, in setting the number of divisions, an upper limit value (predetermined value) is provided so that the number of divisions is not unnecessarily large, and the number of divisions is set to a value not more than the upper limit value. This upper limit value (predetermined value) is determined based on the storage capacity of the image memory 13, the processing power of the image composer 31 or the like.

The division number determiner 22 determines the number of divisions m as described above, and indicates the number of divisions m to the unit exposure determiner 23.

The unit exposure time determiner 23 has a calculation function for determining the unit exposure time when divided exposure is performed with the set exposure time T divided by the number of divisions m. For example, the unit exposure time determiner 23 determines the unit exposure time of each exposure operation at the time of divided exposure by dividing the set exposure time T by the number of divisions m. Then, the unit exposure time determiner 23 indicates the unit exposure time to the exposure controller 24.

Then, the exposure controller 24 indicates divided exposure to the timing generator 14 based on the unit exposure time obtained from the unit exposure time determiner 23.

Consequently, when the image quality priority mode is set, the number of divisions larger than that when the speed priority mode is set is applied, and divided exposure of the CCD image sensor 10 is performed. Then, image composition enables a high-quality shot image with extremely few noises to be obtained.

When the speed priority mode is set, the number of divisions smaller than that when the image quality priority mode is set is applied, so that the time required for transferring all the frame images from the CCD image sensor 10 can be reduced. Further, since the number of frames to be composed in the image composition is small, image composition can be efficiently performed, so that after shooting, the operation can be quickly shifted to the next shooting.

As described above, the digital camera 1 according to the first embodiment has the image quality priority mode and the speed priority mode as the operation modes for divided exposure applied at the time of long-time exposure, and the user can previously select which of the image quality priority mode and the speed priority mode is caused to function at the time of divided exposure. When the user depresses the shutter button 3a to provide an instruction to perform actual shooting and long-time exposure is performed, divided exposure of the CCD image sensor 10 is performed in the digital camera 1. In that case, the shooting controller 24 divides the set exposure time at the time of shooting by the number of divisions defined by the operation mode previously selected by the user, thereby performing divided exposure control of the CCD image sensor 10. This enables increase in noises to be suppressed and divided exposure shooting to be performed with efficiency.

Moreover, in both the image quality priority mode and the speed priority mode, the number of divisions determined in correspondence with the set exposure time is set so as to increase as the set exposure time increases. Consequently, even when the set exposure time is long, increase in the amount of noises included in the shot image can be excellently suppressed.

2. Second Embodiment

Next, a second embodiment will be described. In the above-described first embodiment, divided exposure in a case where the set exposure time (shutter speed) can be detected before actual shooting is started in the digital camera 1 is described. In the second embodiment, divided exposure in a case where bulb shooting is set in the digital camera 1 and the set exposure time is unknown at the point of time when the user depresses the shutter button 3a will be described. The external structure of the digital camera 1 in the second embodiment is similar to that shown in FIGS. 1 and 2. Bulb shooting is a shooting in which exposure of the CCD image sensor 10 is continued while the user is depressing the shutter button 3a.

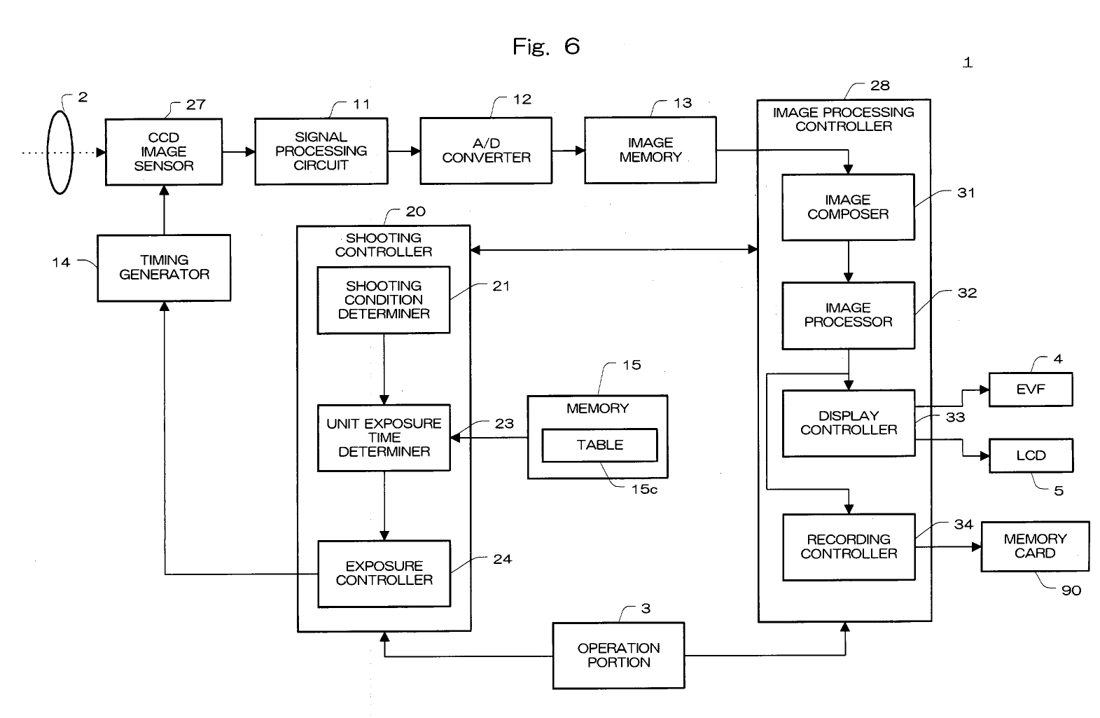

FIG. 5 is a block diagram showing the internal structure of the digital camera 1 in a case where divided exposure is applied in bulb shooting. In FIG. 5, the same elements as those described above are denoted by the same reference numbers, and detailed descriptions thereof are omitted.

As shown in FIG. 5, at the time of bulb shooting, the shooting controller 20 functions as the shooting condition determiner 21, the unit exposure time determiner 23 and the exposure controller 24. In the memory 15, divided exposure information 15b for bulb shooting is stored. The shooting controller 20 determines the unit exposure time based on the divided exposure information 15b stored in the memory 15 at the time of divided exposure.

When the “image quality priority mode” or the “speed priority mode” is set as the exposure operation mode for long-time exposure, the shooting condition determiner 21 identifies the set exposure operation mode, and indicates it to the unit exposure time determiner 23. The exposure operation mode is preset by the user through the operation portion 3.

The unit exposure time determiner 23 accesses the memory 15 based on the set exposure operation mode, and determines the unit exposure time at the time of divided exposure in bulb shooting with reference to the divided exposure information 15b.

In the divided exposure information 15b, the unit exposure time applied at the time of bulb shooting is defined in accordance with the exposure operation mode. For example, when the unit exposure time in the image quality priority mode is t1 and the unit exposure time in the speed priority time is t2, t1<t2.

Showing an example, a relationship between the exposure time of the CCD image sensor 10 and the noise amount is as shown in Table 2.

TABLE 2

| | | | | | | | | |
|---|---|---|---|---|---|---|---|---|
| Exposure | 1/4 | 1/2 | 1 | 2 | 4 | 8 | 16 | 32 |
| Time [sec] | | | | | | | | |
| Noise Amount | 0.0625 | 0.25 | 1 | 4 | 16 | 32 | 256 | 1024 |

In Table 2, the amount of noises accumulated in each pixel when the exposure time is one second is 1, and the noise amounts at other exposure times are shown as ratios to the noise amount when the exposure time is one second.

Assuming now that the critical noise amount in shot images permissible in view of image quality is four times the noise amount when the exposure time is one second, when the “speed priority mode” is set in bulb shooting, the unit exposure time at the time of divided exposure is set to two seconds representative of the critical noise amount. On the contrary, when the “image quality priority mode” is set, the unit exposure time at the time of divided exposure is set so as to be shorter than that when the speed priority mode is set, for example, set to one second.

That is, when bulb shooting is performed, since it cannot be previously determined how many seconds the user continues depressing the shutter button 3a, in this embodiment, a predetermined unit exposure time where the noise amount is not more than a predetermined amount is set in accordance with the previously selected exposure operation mode.

Then, the unit exposure time determiner 23 indicates to the exposure controller 24 the unit exposure time determined as described above.

Then, the exposure controller 24 indicates divided exposure to the timing generator 14 based on the unit exposure time obtained from the unit exposure time determiner 23.

Consequently, divided exposure is performed every unit exposure time also in bulb shooting, and a high-quality shot image with few noises can be obtained. However, when the depression of the shutter button 3a is ended within the predetermined unit exposure time, the exposure operation is ended at that point of time. Therefore, for example, when the shutter button is depressed for 2.5 seconds in the speed priority mode, an image exposed for two seconds and an image exposed for half a second are composed by the image composer.

As described above, in the digital camera 1 according to the second embodiment, the unit exposure time where the noise amount is not more than a predetermined amount is determined in bulb shooting, and divided exposure of the CCD image sensor 10 is repetitively performed every unit exposure time. Consequently, divided exposure can be excellently performed also in bulb shooting, and high-quality shot images with few noises can be obtained.

Since the unit exposure time in the image quality priority mode is shorter than that in the speed priority mode, higher-quality shot images are obtained in the image quality priority mode than in the speed priority mode. On the contrary, in the speed priority mode, image transfer from the CCD image sensor 10 and succeeding image composition can be quickly performed.

3. Third Embodiment

Next, a third embodiment will be described. In this embodiment, a structure for performing a divided exposure control most suitable for the kind of the subject will be described.

For example, when “evening scene” or “night scene” is set as the shooting scene, the subject is generally dark, and therefore, dark-part data occupies most of the part of images obtained by the digital camera 1. For this reason, it is considered that dark noises caused in the CCD image sensor 10 are conspicuous, so that it is necessary to excellently suppress the noises when shooting is performed.

On the contrary, when “portrait” is set as the shooting scene, it is considered that the ratio which the dark-part data bears to images is generally low and it is therefore considered that dark noises caused in the CCD image sensor 10 are inconspicuous compared to those in a case where “evening scene” or “night scene” is set. For this reason, when long-time exposure is performed in a case where “portrait” is set, no problem arises even if the noise suppressing power is lower than that in a case where “evening scene” or “night scene” is set.

Accordingly, in this embodiment, the kind of the subject is determined according to the setting condition of the shooting scene and a divided exposure control suitable for the shooting scene is performed.

FIG. 6 is a block diagram showing the internal structure of the digital camera 1 in a case where a divided exposure suitable for the shooting scene is performed. In FIG. 6, the same elements as those described above are denoted by the same reference numbers, and detailed descriptions thereof are omitted.

As shown in FIG. 6, when the shooting scene is set in the digital camera 1, the shooting controller 20 functions as the shooting condition determiner 21, the unit exposure time determiner 23 and the exposure controller 24. In the memory 15, a table 15c in which the unit exposure time is defined in accordance with the shooting scene is stored. The shooting controller 20 determines the unit exposure time based on the table 15c stored in the memory 15 at the time of divided exposure.

The shooting condition determiner 21 identifies which of the shooting scenes “evening scene,” “night scene” and “portrait” is set, and indicates it to the unit exposure time determiner 23. The shooting scene is previously set by the user through the operation portion 3. When no shooting scene is set, the exposure operation described in the first embodiment is performed.

The unit exposure time determiner 23 accesses the memory 15 based on the set shooting scene, and determines the unit exposure time suitable for the currently set shooting scene with reference to the table 15c.

In the table 15c, the unit exposure time applied for each shooting scene is defined. For example, when “evening scene” or “night scene” is set, a unit exposure time with high noise suppressing power is adopted to excellently suppress noise. On the contrary, when “portrait” is set, a unit exposure time with lower noise suppressing power than that when “evening scene” or “night scene” is set is adopted so that frame image transfer and image composition can be efficiently performed. That is, when the unit exposure time when “evening scene” or “night scene” is set is t3 and the unit exposure time when “portrait” is set is t4, t3<t4.

Showing an example, information as shown in the following Table 3 is stored in the table 15c:

TABLE 3

| | Evening Scene/ | |
|---|---|---|
| Shooting Scene | Night Scene | Portrait |
| Unit Exposure Time [sec] | 1 | 2 |

In the information shown in Table 3, when “evening scene” or “night scene” is set as the shooting scene, the unit exposure time is set to one second. When “portrait” is set, the unit exposure time is set to two seconds. The unit exposure time (two seconds) set when “portrait” is set is determined in accordance with the above-described critical noise amount.

Then, the unit exposure time determiner 23 indicates to the exposure controller 24 the unit exposure time determined as described above.

Then, the exposure controller 24 indicates divided exposure to the timing generator 14 based on the unit exposure time obtained from the unit exposure time determiner 23.

Consequently, when a shooting scene is set, a unit exposure time suitable for the kind of the subject is set. Then, divided exposure is performed every unit exposure time, and a high-quality shot image with few noises can be obtained.

As described above, in the digital camera 1 according to the third embodiment, the unit exposure time at the time of divided exposure is determined in accordance with the setting of the shooting scene. When exposure of the CCD image sensor 10 is performed, divided exposure control of the CCD image sensor 10 is performed every determined unit exposure time. Consequently, a divided exposure most suitable for the kind of the subject can be performed.

For example, when an “evening scene” or a “night scene” is shot, since the subject is generally in a dark environment, noise components are conspicuous in the finally obtained shot image. To excellently suppress the noise components, a divided exposure of a short unit exposure time is performed. On the contrary, when shooting is performed with “portrait,” noise components are generally inconspicuous compared to those in the cases of “evening scene” and “night scene.” For this reason, by setting a longer unit exposure time than in the cases of “evening scene” and “night scene,” reduction in overall shooting time is achieved.

Therefore, according to the third embodiment, a divided exposure most suitable for the kind of the subject, particularly the brightness of the subject can be performed.

4. Modification

While embodiments of the present invention have been described, the present invention is not limited to the contents described above.

For example, while in the description given above, long-time exposure is an exposure where the set exposure time is not less than one second, the present invention is not limited thereto.

Moreover, while the above-described shooting condition determiner 21 determines setting conditions related to shooting conditions such as the exposure operation mode, bulb shooting and the shooting scene, the shooting conditions may include other elements as well.

Although the present invention has been fully described by way of examples with reference to the accompanying drawings, it is to be noted that various change and modifications will be apparent to those skilled in the art. Therefore, unless otherwise such changes and modifications depart from the scope of the present invention, they should be construed as being including therein.

What is claimed is:

1. An image capturing device obtaining a plurality of images by performing divided exposure of an image sensor for forming a subject image, comprising:
a selector for selecting one of an image quality priority mode in which the number of divisions at the time of divided exposure is set to a first value and a shooting speed priority mode in which the number of divisions is set to a second value lower than the first value;
a controller for performing, when exposure of the image sensor is performed, a divided exposure control of the image sensor by dividing a set exposure time at the time of shooting by the number of divisions defined by the mode selected by the selector; and
an image generator for generating a shot image of the subject by composing the plurality of images obtained by the divided exposure.

2. An image capturing device according to claim 1, wherein said first value is determined in accordance with the set exposure time, and is set so as to increase as the at exposure time increases.

3. An image capturing device according to claim 1, wherein said second value is determined in accordance with the set exposure time, and is set so as to increase as the set exposure time increases.

4. An image capturing device according to claim 1, further comprises a memory for storing the number of divisions defined by a relationship between the set exposure time and said modes.

5. An image capturing method obtaining a plurality of images by performing divided exposure of an image sensor for forming a subject image, comprising the steps of:
selecting one of an image quality priority mode in which the number of divisions at the time of divided exposure is set to a first value and a shooting speed priority mode in which the number of divisions is set to a second value lower than the first value;
performing, when exposure of the image sensor is performed, a divided exposure control of the image sensor by dividing a set exposure time at the time of shooting by the number of divisions defined by the selected mode; and
generating a shot image of the subject by composing the plurality of images obtained by the divided exposure.

6. An image capturing device, comprising:
an image sensor for forming a subject image;
a first selector for selecting a bulb shooting mode;
an exposure time determiner for determining a unit exposure time in the bulb shooting mode;
a controller for repetitively performing divided exposure of the image sensor every unit exposure time during the bulb shooting; and
an image generator for generating a shot image of the subject by composing a plurality of images generated by the divided exposure performed every unit exposure time.

7. An image capturing device according to claim 6, wherein said exposure time determiner determines a unit exposure time where the amount of noises is not more than a predetermined amount.

8. An image capturing device according to claim 7, further comprises a second selector for selecting one of an image quality priority mode and a shooting speed priority mode, and said exposure time determiner determines a unit exposure time in accordance with the mode selected by the second selector.

9. An image capturing device according to claim 8, wherein, when said image quality priority mode is selected, said exposure time determiner determines a unit exposure time so as to be shorter than that when said shooting speed priority mode is selected.

10. An image capturing method, comprising the steps of:
forming a subject image;
selecting a bulb shooting mode;
determining a unit exposure time in the bulb shooting mode;
repetitively performing divided exposure of the image sensor every unit exposure time during the bulb shooting; and
generating a shot image of the subject by composing a plurality of images generated by the divided exposure performed every unit exposure time.

11. An image capturing device obtaining a plurality of images by performing divided exposure of an image sensor for forming a subject image, comprising:
a shooting condition determiner for determining a shooting condition when a subject is shot;
a unit exposure time determiner for determining a unit exposure time at the time of the divided exposure in accordance with the shooting condition;
a controller for performing a divided exposure control of the image sensor every unit exposure time determined by the unit exposure time determiner when exposure of the image sensor is performed; and
an image generator for generating a shot image of the subject by composing the plurality of images obtained by the divided exposure.

12. An image capturing device according to claim 11, wherein said shooting condition determiner determines, as the shooting condition, the setting condition of the shooting scene set in accordance with the kind of the subject.

13. An image capturing device according to claim 12, further comprises a memory for storing a relationship between the unit exposure time and said shooting scene.

14. An image capturing device according to claim 12, wherein said setting condition of the shooting scene includes a night scene setting and a portrait setting.

15. An image capturing device according to claim 14, wherein said determiner sets the unit exposure time in a case where the night scene setting is made, to a higher value than the unit exposure time in a case where the portrait setting is made.

16. An image capturing device according to claim 12, wherein said setting condition of the shooting scene includes a evening scene setting and a portrait setting.

17. An image capturing device according to claim 16, wherein said determiner sets the unit exposure time in a case where the evening scene setting is made, to a higher value than the unit exposure time in a case where the portrait setting is made.

18. An image capturing method obtaining a plurality of images by performing divided exposure of an image sensor for forming a subject image, comprising the steps of:
determining a shooting condition when a subject is shot;
determining a unit exposure time at the time of the divided exposure in accordance with the shooting condition;
performing a divided exposure control of the image sensor every unit exposure time determined when exposure of the image sensor is performed; and
generating a shot image of the subject by composing the plurality of images obtained by the divided exposure.
